(19) United States
(12) Patent Application Publication
(10) Pub. No.: US 2022/0349514 A1
(43) Pub. Date: Nov. 3, 2022

(54) MODULAR LARGE SPHERICAL TANK INTERNAL DETECTION DEVICE WITH SELF-LOCKING FUNCTION

(71) Applicant: ANHUI UNIVERSITY OF TECHNOLOGY, Ma'anshan (CN)

(72) Inventors: Qingyun LIU, Ma'anshan (CN); Tianyue WU, Ma'anshan (CN); Tao LIU, Ma'anshan (CN); Yuanyang HE, Ma'anshan (CN)

(73) Assignee: ANHUI UNIVERSITY OF TECHNOLOGY, Ma'anshan (CN)

(21) Appl. No.: 17/629,480

(22) PCT Filed: Apr. 2, 2021
(86) PCT No.: PCT/CN2021/085247

§ 371 Date: Jan. 24, 2022

(30) Foreign Application Priority Data
Sep. 1, 2020 (CN) 202010900890.7

(51) Int. Cl. F16M 11/10; F16H 37/12; F16M 11/20; F16M 11/24; H02K 7/116

(52) U.S. Cl. CPC F16M 11/10; F16H 37/122; F16M 11/2035; F16M 11/24; H02K 7/1166; F16M 2200/065; F16M 2200/068

(57) ABSTRACT

The present disclosure discloses a modular large spherical tank internal detection device with a self-locking function, and belongs to the technical field of safety detection of large spherical tanks. The detection device includes a transmission group and a detection group. A movable pin is matched with the rotation of a second motor in an unconnected state, so that inner central shafts rotate to realize up-down movement of a detecting instrument in a vertical plane. The movable pin is matched with the rotation of a first motor in a connected state, so that the whole detection device rotates round a central axis of a large spherical tank to realize horizontal circumferential movement of the detecting instrument. All detection of a spherical surface inside the large spherical tank can be completed by combining two types of movement of the detecting instrument.

### TECHNICAL FIELD

The present disclosure belongs to the technical field of safety detection of large spherical tanks, and particularly, relates to a modular large spherical tank internal detection device with a self-locking function.

### BACKGROUND ART

At present, as a storage pressure vessel commonly used in heavy industries, such as petroleum, chemical industry, and metallurgy, a spherical tank has the characteristics of large size, small floor area, easiness in operation and management, and the like. However, the spherical tank is made by welding steel plates of different specifications. Due to the particularity of the industry where it is applied, the safety degree of a weld is particularly critical, and certain requirements need to be put forward for the safety of the weld. The spherical tank not only needs to be detected after being manufactured, but also needs to be detected after reaching a certain service life. Therefore, periodic detection of the spherical tank becomes a critical process. However, the volume of the spherical tank is too large and the workload of pure manual detection is heavy. Therefore, it is of great significance to put forward a device that can perform safety detection on the interior of the large spherical tank.

In the existing spherical tank detection technologies, most of them only use the form of fixing one end of a central shaft, and the transmission stability of a device is poor; a mounting process of the detection device is cumbersome, which increases the workload of workers and reduces the work efficiency; most devices do not consider potential safety hazards in an actual operation. For example, in the case of sudden power failure, the safety of detecting instruments and workers cannot be guaranteed.

### SUMMARY

Aiming at the deficiencies of the existing large spherical tank internal detection technology, the present disclosure provides a modular large spherical tank internal detection device with a self-locking function. By adopting the self-locking function of the device, a safety coefficient of the detection device can be improved, and the safety of detecting instruments and workers can be guaranteed in the case of sudden power failure. By adopting a modular assembly method of the device, the mounting efficiency can be greatly improved without a rope or a chain, long-distance transmission of the device can be realized, and the device can be applied to detecting large spherical tanks with different diameters.

The modular large spherical tank internal detection device with a self-locking function provided by the present disclosure includes a transmission group 1 and a detection group 2. A vertical center line of the transmission group 1 coincides with a vertical center line of a large spherical tank. An upper end of the transmission group 1 is fixedly connected to a top table of the large spherical tank. A lower end of the transmission group 1 is fixedly connected to the ground. The detection group 2 is connected to a middle part of the transmission group 1.

The transmission group 1 includes a bottom table 1-1, a lower central shaft 1-2, a first central shaft 1-3-1, a second central shaft 1-3-2, a third central shaft 1-3-3, a fourth central shaft 1-3-4, a fifth central shaft 1-3-5, a sixth central shaft 1-3-6, a seventh central shaft 1-3-7, an eighth central shaft 1-3-8, a ninth central shaft 1-3-9, a tenth central shaft 1-3-10, a gear shaft 1-4, a worm shaft 1-5, an upper central shaft 1-6, a lower sleeve 1-7, a first sleeve 1-8-1, a second sleeve 1-8-2, a third sleeve 1-8-3, a fourth sleeve 1-8-4, a fifth sleeve 1-8-5, a sixth sleeve 1-8-6, a first connecting piece 1-9, a platform 1-10, a second connecting piece 1-11, a middle sleeve 1-12, a worm gear frame 1-13, an end cover 1-14, a first motor frame 1-15, a first pinion 1-16, a first motor 1-17, a gear wheel 1-18, a second pinion 1-19, a second motor frame 1-20, a second motor 1-21, and a movable pin 1-22. A center line of the bottom table 1-1 coincides with a center line of the large spherical tank. A lower end of the bottom table 1-1 is fixedly connected to the ground. An upper end of the bottom table 1-1 is connected to a lower end of the lower central shaft 1-2. An upper end of the lower central shaft 1-2 is connected to a lower end of the first central shaft 1-3-1. An upper end of the first central shaft 1-3-1 is connected to a lower end of the gear shaft 1-4. An upper end of the gear shaft 1-4 is connected to a lower end of the second central shaft 1-3-2. An upper end of the second central shaft 1-3-2 is connected to a lower end of the third central shaft 1-3-3. An upper end of the third central shaft 1-3-3 is connected to a lower end of the fourth central shaft 1-3-4. An upper end of the fourth central shaft 1-3-4 is connected to a lower end of the fifth central shaft 1-3-5. An upper end of the fifth central shaft 1-3-5 is connected to a lower end of the sixth central shaft 1-3-6. An upper end of the sixth central shaft 1-3-6 is connected to a lower end of the worm shaft 1-5. An upper end of the worm shaft 1-5 is connected to a lower end of the seventh central shaft 1-3-7. An upper end of the seventh central shaft 1-3-7 is connected to a lower end of the eighth central shaft 1-3-8. An upper end of the eighth central shaft 1-3-8 is connected to a lower end of the ninth central shaft 1-3-9. An upper end of the ninth central shaft 1-3-9 is connected to a lower end of the tenth central shaft 1-3-10. An upper end of the tenth central shaft 1-3-10 is connected to a lower end of the upper central shaft 1-6. An upper end of the upper central shaft 1-6 is connected to the end cover 1-14. The end cover 1-14 is fixedly connected to a boss at a top end of the large spherical tank. A lower sleeve 1-7 is arranged on the lower central shaft 1-2 in a sleeving manner. An upper end of the lower sleeve 1-7 is connected to a lower end of the first sleeve 1-8-1. The first sleeve 1-8-1 is arranged on the first central shaft 1-3-1 in a sleeving manner. An upper end of the first sleeve 1-8-1 is connected to a lower end of the first connector 1-9. The first connecting piece 1-9 is arranged on the gear shaft 1-4 in a sleeving manner. An upper end of the first connecting piece 1-9 is fixedly connected to a lower end of the platform 1-10. A first through hole is formed in the middle of the platform 1-10. The platform 1-10 is arranged on the gear shaft 1-4 in a sleeving manner through the first through hole. An upper end of the platform 1-10 is connected to a lower end of the second connecting piece 1-11. The second connecting piece 1-11 is arranged on the gear shaft 1-4 in a sleeving manner. An upper end of the second connecting piece 1-11 is connected to a lower end of the middle sleeve 1-12. The middle sleeve 1-12 is arranged on the gear shaft 1-4 in a sleeving manner. An upper end of the middle sleeve 1-12 is connected to a lower end of the second sleeve 1-8-2. The second sleeve 1-8-2 is arranged on the second central shaft 1-3-2 in a sleeving manner. An upper end of the second sleeve 1-8-2 is connected to a lower end of the third sleeve 1-8-3. The third sleeve 1-8-3 is arranged on the third central shaft 1-3-3 in a sleeving manner. An upper end of the third sleeve 1-8-3 is connected to a lower end of the fourth sleeve 1-8-4. The fourth sleeve 1-8-4 is arranged on the fourth central shaft 1-3-4 in a sleeving manner. An upper end of the fourth sleeve 1-8-4 is connected to a lower end of the fifth sleeve 1-8-5. The fifth sleeve 1-8-5 is arranged on the fifth central shaft 1-3-5 in a sleeving manner. An upper end of the fifth sleeve 1-8-5 is connected to a lower end of the sixth sleeve 1-8-6. The sixth sleeve 1-8-6 is arranged on the sixth central shaft 1-3-6 in a sleeving manner. A second through hole is formed in the middle of the worm gear frame 1-13. The worm gear frame 1-13 is arranged on the sixth central spindle 1-3-6 in a sleeving manner through the second through hole. A lower end of the boss of the worm gear frame 1-13 is connected to an upper end of the sixth sleeve 1-8-6. An upper end of the boss of the worm gear frame 1-13 is connected to a lower end of the worm shaft 1-5. The first motor frame 1-15 is mounted on the bottom table 1-1. The first motor 1-17 is mounted on the first motor frame 1-15. The first pinion 1-16 is mounted on the first motor 1-17. The first gear wheel 1-18 is engaged with the first pinion 1-16. The first gear wheel 1-18 is in key connection with the lower sleeve 1-7. The second motor frame 1-20 is mounted on the platform 1-10. The second motor 1-21 is mounted on the second motor frame 1-20. The second pinion 1-19 is mounted on the second motor 1-21. The second pinion 1-19 is engaged with the gear shaft 1-4. There are two connection modes between the middle sleeve 1-12 and the gear shaft 1-4, one is that the two are connected to each other through the movable pin 1-22, and the other is that the two are not connected with each other; and the movable pin 1-22 is capable of being disassembled manually.

The detection group 2 includes a first worm gear 2-1-1, a second worm gear 2-1-2, a first transverse shaft 2-2-1, a second transverse shaft 2-2-2, a third transverse shaft 2-2-3, a fourth transverse shaft 2-2-4, a first long connecting block 2-3-1, a second long connecting block 2-3-2, a third long connecting block 2-3-3, a fourth long connecting block 2-3-4, a first long arm 2-4-1, a second long arm 2-4-2, a third long arm 2-4-3, a fourth long arm 2-4-4, a first short connecting block 2-5-1, a second short connecting block 2-5-2, a third short connecting block 2-5-3, a fourth short connecting block 2-5-4, a first detection platform 2-6-1, and a second detection platform 2-6-2. The first transverse shaft 2-2-1, the second transverse shaft 2-2-2, the third transverse shaft 2-2-3, and the fourth transverse shaft 2-2-4 are respectively connected to the worm gear frame 1-13 in the transmission group 1. The first worm gear 2-1-1 is in key connection with the first transverse shaft 2-2-1. The second worm gear 2-1-2 is in key connection with the second transverse shaft 2-2-2. The first worm gear 2-1-1 is engaged with the worm shaft 1-5 in the transmission group 1. The second worm gear 2-1-2 is engaged with the worm shaft 1-5 in the transmission group 1. The first worm gear 2-1-1 and the second worm gear 2-1-2 are symmetrically arranged on two sides of the worm shaft 1-5. A side of the first long connecting block 2-3-1 is fixedly connected to the first worm gear 2-1-1. One end of the first long connecting block 2-3-1 is connected to the first transverse shaft 2-2-1. The other end of the first long connecting block 2-3-1 is fixedly connected to one end of the first long arm 2-4-1. The other end of the first long arm 2-4-1 is fixedly connected to the first short connecting block 2-5-1. A side of the second long connecting block 2-3-2 is fixedly connected to the second worm gear 2-1-2. One end of the second long connecting block 2-3-2 is connected to the second transverse shaft 2-2-2. The other end of the second long connecting block 2-3-2 is fixedly connected to one end of the second long arm 2-4-2. The other end of the second long arm 2-4-2 is fixedly connected to the second short connecting block 2-5-2. One end of the third long connecting block 2-3-3 is connected to the third transverse shaft 2-2-3. The other end of the third long connecting block 2-3-3 is fixedly connected to one end of the third long arm 2-4-3. The other end of the third long arm 2-4-3 is fixedly connected to the third short connecting block 2-5-3. One end of the fourth long connecting block 2-3-4 is connected to the fourth transverse shaft 2-2-4. The other end of the fourth long connecting block 2-3-4 is fixedly connected to one end of the fourth long arm 2-4-4. The other end of the fourth long arm 2-4-4 is fixedly connected to the fourth short connecting block 2-5-4. An upper end of the first detection platform 2-6-1 is connected to the first short connecting block 2-5-1. A lower end of the first detection platform 2-6-1 is connected to the third short connecting block 2-5-3. An upper end of the second detection platform 2-6-2 is connected to the second short connecting block 2-5-2. A lower end of the second detection platform 2-6-2 is connected to the fourth short connecting block 2-5-4.

The detection device can realize internal detection of large spherical tanks with different diameters by selecting different numbers and types of transmission modules without a rope or a chain. In the case of sudden power failure, by using the self-locking function of a mechanism, the safety coefficient of the detection device is improved, and the safety of detecting instruments and workers are guaranteed.

### BRIEF DESCRIPTION OF THE DRAWINGS

FIG. 1 is a structural schematic diagram of a detection device of the present disclosure;

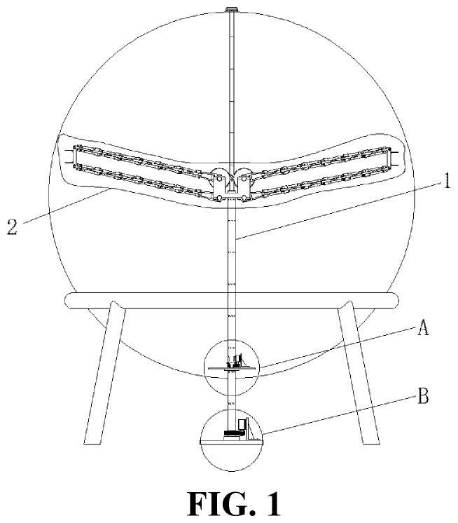

FIG. 2 is a structural schematic diagram of the detection device of the present disclosure in a state that a long arm swings downwards;

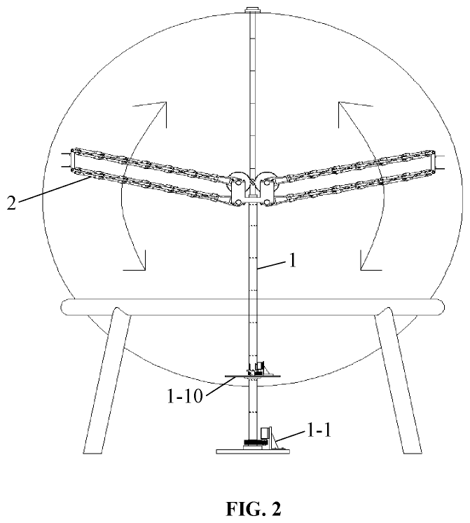

FIG. 3 is a structural schematic diagram of a transmission group in the detection device of the present disclosure;

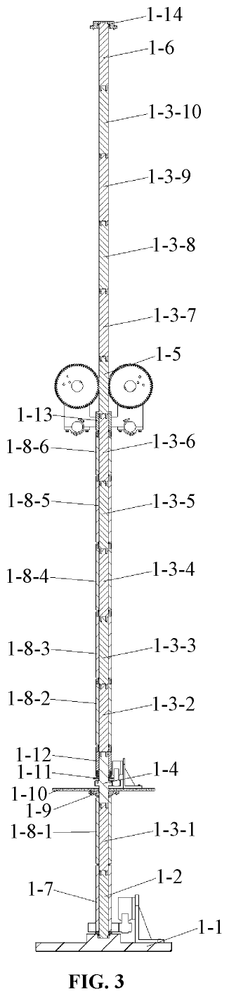

FIG. 4 is a structural schematic diagram of a detection group in the detection device of the present disclosure;

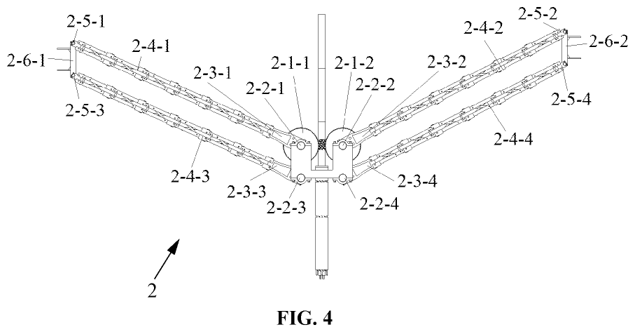

FIG. 5 is a structural schematic diagram at A in FIG. 1;

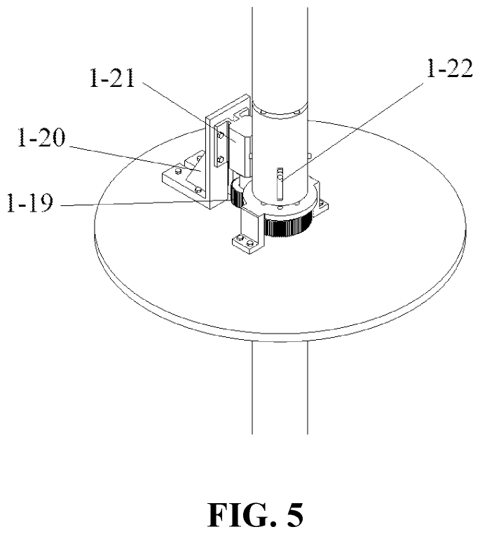

FIG. 6 is a schematic structural diagram at B in FIG. 1;

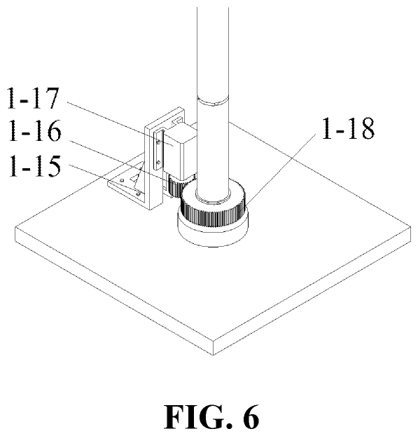

FIG. 7 is a structural schematic diagram of a lower central shaft in the detection device of the present disclosure;

FIG. 8 is a structural schematic diagram of a first central shaft in the detection device of the present disclosure;

FIG. 9 is a structural schematic diagram of a gear shaft in the detection device of the present disclosure;

FIG. 10 is a structural schematic diagram of a worm shaft in the detection device of the present disclosure;

FIG. 11 is a structural schematic diagram of a worm gear frame in the detection device of the present disclosure;

FIG. 12 is a structural schematic diagram of an upper central shaft in the detection device of the present disclosure;

FIG. 13 is a structural schematic diagram of a lower sleeve in the detection device of the present disclosure;

FIG. 14 is a structural schematic diagram of a first sleeve in the detection device of the present disclosure;

FIG. 15 is a structural schematic diagram of a first connecting piece in the detection device of the present disclosure;

FIG. 16 is a structural schematic diagram of a second connecting piece in the detection device of the present disclosure;

FIG. 17 is a structural schematic diagram of a middle sleeve in the detection device of the present disclosure; and

FIG. 18 is a structural schematic diagram of a long arm unit in the detection device of the present disclosure.

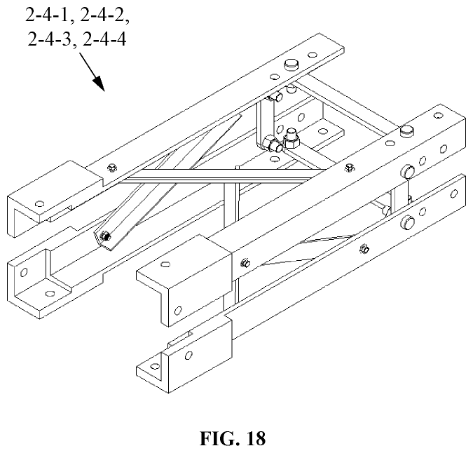

Reference signs in the drawings: 1: transmission group, 1-1: bottom table, 1-2: lower central shaft, 1-3-1: first central shaft, 1-3-2: second central shaft, 1-3-3: third central shaft, 1-3-4: fourth central shaft, 1-3-5: fifth central shaft, 1-3-6: sixth central shaft, 1-3-7: seventh central shaft, 1-3-8: eighth central shaft, 1-3-9: ninth central shaft, 1-3-10: tenth central shaft, 1-4: gear shaft, 1-5: worm shaft, 1-6: upper central shaft, 1-7: lower sleeve, 1-8-1: first sleeve, 1-8-2: second sleeve, 1-8-3: third sleeve, 1-8-4: fourth sleeve, 1-8-5: fifth sleeve, 1-8-6: sixth sleeve, 1-9: first connecting piece, 1-10: platform, 1-11: second connecting piece, 1-12: middle sleeve, 1-13: worm gear frame, 1-14: end cover, 1-15: first motor frame, 1-16: first pinion, 1-17: first motor, 1-18: first gear wheel, 1-19: second pinion, 1-20: second motor frame, 1-21: second motor, and 1-22: movable pin; and 2: detection group, 2-1-1: first worm gear, 2-1-2: second worm gear, 2-2-1: first transverse shaft, 2-2-2: second transverse shaft, 2-2-3: third transverse shaft, 2-2-4: fourth transverse shaft, 2-3-1: first long connecting block, 2-3-2: second long connecting block, 2-3-3: third long connecting block, 2-3-4: fourth long connecting block, 2-4-1: first long arm, 2-4-2: second long arm, 2-4-3: third long arm, 2-4-4: fourth long arm, 2-5-1: first short connecting block, 2-5-2: second short connecting block, 2-5-3: third short connecting block, 2-5-4: fourth short connecting block, 2-6-1: first detection platform, and 2-6-2: second detection platform.

### DETAILED DESCRIPTION OF THE EMBODIMENTS

The present disclosure will be further described below with reference to accompanying drawings.

The modular large spherical tank internal detection device with a self-locking function provided by the present disclosure includes a transmission group 1 and a detection group 2. A vertical center line of the transmission group 1 coincides with a vertical center line of a large spherical tank. An upper end of the transmission group 1 is fixedly connected to a top table of the large spherical tank. A lower end of the transmission group 1 is fixedly connected to the ground. The detection group 2 is connected to a middle part of the transmission group 1.

The transmission group 1 includes a bottom table 1-1, a lower central shaft 1-2, a first central shaft 1-3-1, a second central shaft 1-3-2, a third central shaft 1-3-3, a fourth central shaft 1-3-4, a fifth central shaft 1-3-5, a sixth central shaft 1-3-6, a seventh central shaft 1-3-7, an eighth central shaft 1-3-8, a ninth central shaft 1-3-9, a tenth central shaft 1-3-10, a gear shaft 1-4, a worm shaft 1-5, an upper central shaft 1-6, a lower sleeve 1-7, a first sleeve 1-8-1, a second sleeve 1-8-2, a third sleeve 1-8-3, a fourth sleeve 1-8-4, a fifth sleeve 1-8-5, a sixth sleeve 1-8-6, a first connecting piece 1-9, a platform 1-10, a second connecting piece 1-11, a middle sleeve 1-12, a worm gear frame 1-13, an end cover 1-14, a first motor frame 1-15, a first pinion 1-16, a first motor 1-17, a gear wheel 1-18, a second pinion 1-19, a second motor frame 1-20, a second motor 1-21, and a movable pin 1-22.

The first central shaft 1-3-1, the second central shaft 1-3-2, the third central shaft 1-3-3, the fourth central shaft 1-3-4, the fifth central shaft 1-3-5, the sixth central shaft 1-3-6, the seventh central shaft 1-3-7, the eighth central shaft 1-3-8, the ninth central shaft 1-3-9, and the tenth central shaft 1-3-10 have the same structure. The first sleeve 1-8-1, the second sleeve 1-8-2, the third sleeve 1-8-3, the fourth sleeve 1-8-4, the fifth sleeve 1-8-5, and the sixth sleeve 1-8-6 have the same structure.

The lower central shaft 1-2, the first central shaft 1-3-1 to the tenth central shaft 1-3-10, the gear shaft 1-4, the worm shaft 1-5, the upper central shaft 1-6, the lower sleeve 1-7, the first sleeve 1-8-1 to the sixth sleeve 1-8-6, the first connecting piece 1-9, the platform 1-10, the second connecting piece 1-11, the middle sleeve 1-12, the worm gear frame 1-13, and the end cover 1-14 serve as mounting module units in the transmission group 1. The number of the mounting module units may be determined according to detection requirements of spherical tanks with different diameters.

A thrust bearing is mounted between the lower central shaft 1-2 and the bottom table 1-1. A thrust bearing is mounted between the first sleeve 1-8-1 and the lower sleeve 1-7. A thrust bearing is mounted between the first connecting piece 1-9 and the first sleeve 1-8-1. A thrust bearing is mounted between the second connecting piece 1-11 and the gear shaft 1-4. A thrust bearing is mounted between the middle sleeve 1-12 and the second connecting piece 1-11. A thrust bearing is mounted between the middle sleeve 1-12 and the second sleeve 1-8-2. A thrust bearing is mounted between the second sleeve 1-8-2 and the third sleeve 1-8-3. A thrust bearing is mounted between the third sleeve 1-8-3 and the fourth sleeve 1-8-4. A thrust bearing is mounted between the fourth sleeve 1-8-4 and the fifth sleeve 1-8-5. A thrust bearing is mounted between the third sleeve 1-8-5 and the fourth sleeve 1-8-6. A thrust bearing is mounted between the sixth sleeve 1-8-6 and the worm gear frame 1-13.

The detection group 2 includes a first worm gear 2-1-1, a second worm gear 2-1-2, a first transverse shaft 2-2-1, a second transverse shaft 2-2-2, a third transverse shaft 2-2-3, a fourth transverse shaft 2-2-4, a first long connecting block 2-3-1, a second long connecting block 2-3-2, a third long connecting block 2-3-3, a fourth long connecting block 2-3-4, a first long arm 2-4-1, a second long arm 2-4-2, a third long arm 2-4-3, a fourth long arm 2-4-4, a first short connecting block 2-5-1, a second short connecting block 2-5-2, a third short connecting block 2-5-3, a fourth short connecting block 2-5-4, a first detection platform 2-6-1, and a second detection platform 2-6-2. The first detection platform 2-6-1, the first long arm 2-4-1, the third long arm 2-4-3, and a center connecting line of the first transverse shaft 2-2-1 and the third transverse shaft 2-2-3 form a parallelogram structure. The second detection platform 2-6-2, the second long arm 2-4-2, the fourth long arm 2-4-4, and a center connecting line of the second transverse shaft 2-2-2 and the fourth transverse shaft 2-2-4 form a parallelogram structure. All of the first long arm 2-4-1, the second long arm 2-4-2, the third long arm 2-4-3, and the fourth long arm 2-4-4 consist of long arm units.

When the device of the present disclosure is in the case of sudden power failure, the first long arm 2-4-1, the second long arm 2-4-2, the third long arm 2-4-3, and the fourth long arm 2-4-4 tend to move downward under the action of gravity. Since the device of the present disclosure has a worm gear-worm structure, the first long arm 2-4-1 is fixedly connected to the first worm gear 2-1-1, and the second long arm 2-4-2 is fixedly connected to the second worm gear 2-1-2, the four long arms cannot drop suddenly under the characteristic of self-locking of a worm gear and a worm, which guarantees the safety of the detection device and workers.

When the movable pin 1-22 is not mounted, the movable pin 1-22 is matched with the rotation of the second motor 1-21, power is transmitted from the second pinion 1-19, passes through the gear shaft 1-4, the second central shaft 1-3-2, the third central shaft 1-3-3, the fourth central shaft 1-3-4, the fifth central shaft 1-3-5, and the sixth central shaft 1-3-6, reaches the worm shaft 1-5, and drives the worm shaft 1-5 to rotate, so that the first worm gear 2-1-1 and the second worm gear 2-1-2 move, the first long arm 2-4-1, the second long arm 2-4-2, the third long arm 2-4-3, and the fourth long arm 2-4-4 move up and down to realize up-down movement of the detection device in a vertical plane of the large spherical tank.

When the movable pin 1-22 is mounted, the movable pin 1-22 connects the middle sleeve 1-12 and the gear shaft 1-4 and is matched with the rotation of the first motor 1-17, power is transmitted from the first pinion 1-16, and passes through the first gear wheel 1-18, the lower sleeve 1-7, the first sleeve 1-8-1, the first connecting piece 1-9, the platform 1-10, and the second connecting piece 1-11 in sequence. When the second connecting piece 1-11 rotates at this moment: one path of power is transmitted out from the second connecting piece 1-11, passes through the middle sleeve 1-12, the second sleeve 1-8-2, the third sleeve 1-8-3, the fourth sleeve 1-8-4, the fifth sleeve 1-8-5, and the sixth sleeve 1-8-6, and reaches the worm gear frame 1-13, so that the worm gear frame 1-13 performs horizontal rotational movement around a central axis of the large spherical tank. Since the detection group 2 is connected to the worm gear frame 1-13, the detecting instrument performs the horizontal rotational movement around the central axis of the large spherical tank. The other path of power is transmitted from the second connecting piece 1-11, passes through the gear shaft 1-4, the second central shaft 1-3-2, the third central shaft 1-3-3, the fourth central shaft 1-3-4, the fifth central shaft 1-3-5, and the sixth central shaft 1-3-6 in sequence, and reaches the worm shaft 1-5, so that the worm shaft 1-5 rotates. Because both paths of power are transmitted from the second connecting piece 1-11, the worm shaft 1-5 and the worm gear frame 1-13 rotate synchronously. At this moment, the whole device can only perform horizontal circumferential rotation around the central axis of the large spherical tank. With regard to a spherical surface inside the large spherical tank, all detection of the spherical surface inside the large spherical tank can be completed by combining two movement states of the detecting device of the present disclosure.

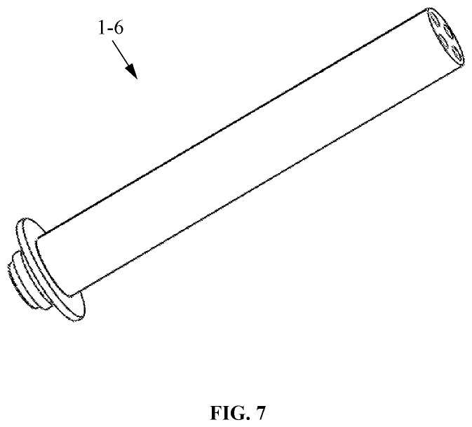

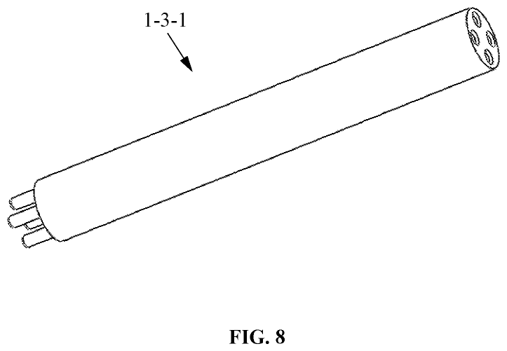

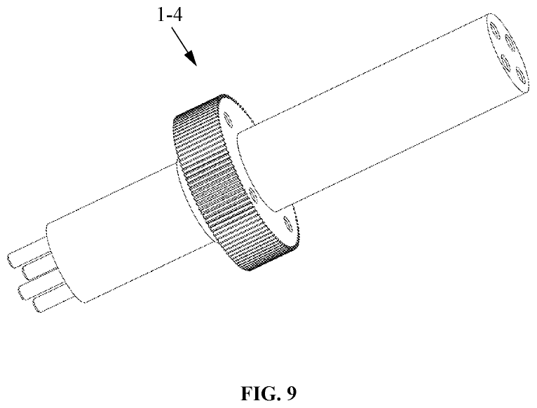

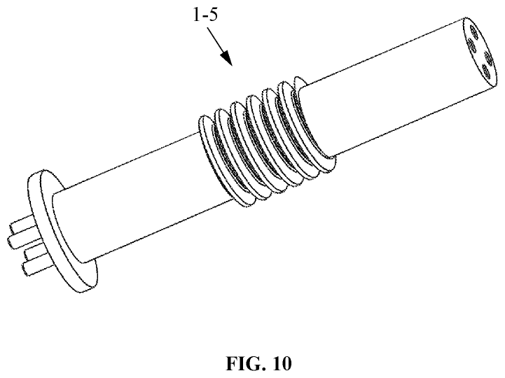

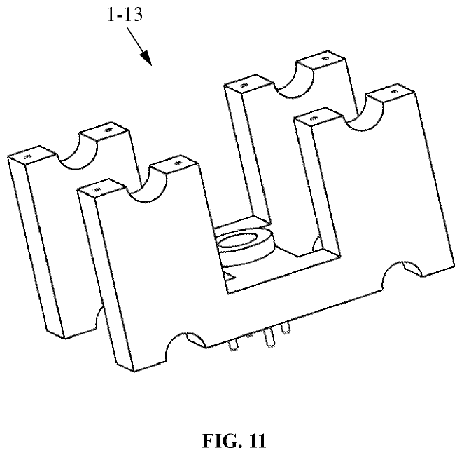

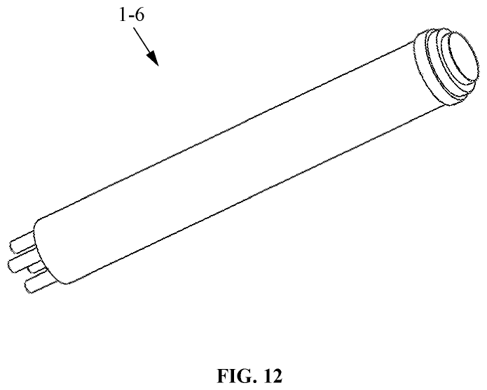

A connector is arranged at a lower end of the upper central shaft 1-6, as shown in FIG. 12. A connecting hole is formed in an upper end of the upper central shaft 1-6, as shown in FIG. 7. A connector is arranged at a lower end of the first central shaft 1-3-1, and a connecting hole is formed in an upper end of the first central shaft 1-3-1, as shown in FIG. 8. A connector is arranged at a lower end of the gear shaft 1-4, a connecting hole is formed in an upper end of the gear shaft 1-4, and a hole is formed in a middle gear, as shown in FIG. 9. A connector is arranged at a lower end of the worm shaft 1-5, a connecting hole is formed in an upper end of the worm shaft 1-5, as shown in FIG. 10. A front surface of the worm gear frame 1-13 is U-shaped, an upper surface is I-shaped, a shaft seat hole is formed in an upper end face and a lower end face of a vertical connecting arm, a boss is formed at a central position of the worm gear frame 1-13, a through hole is formed in the center of the boss, and a connector is arranged at the lower end of the boss, as shown in FIG. 11.

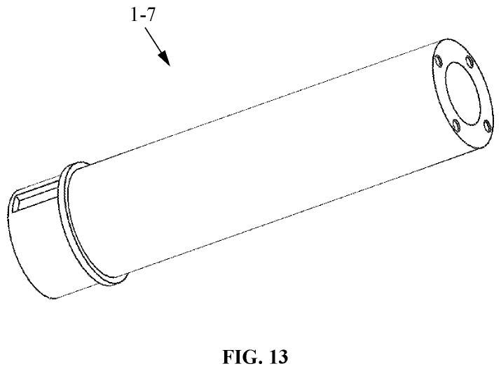

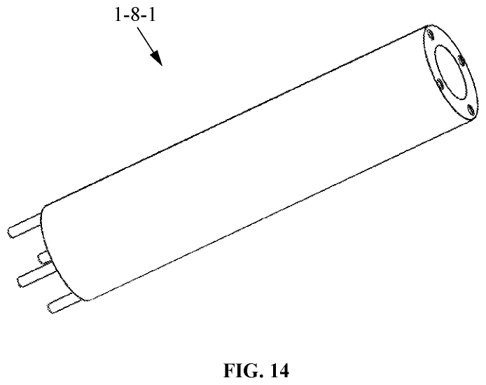

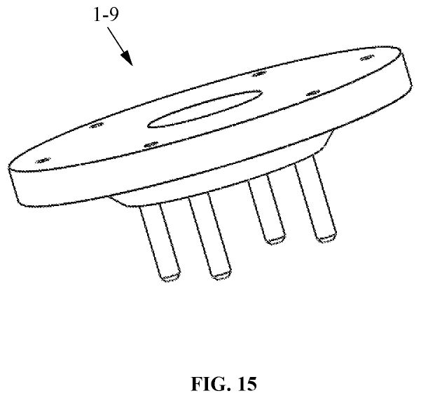

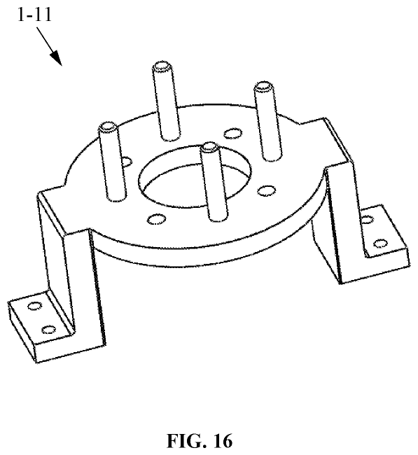

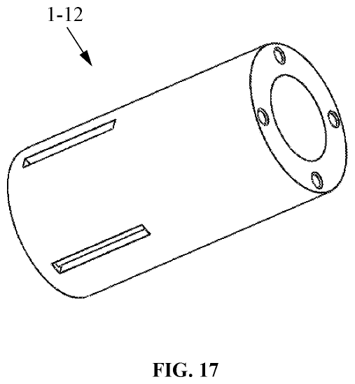

The first connecting piece 1-9 is in a two-stage boss shape, a connector is arranged at a lower end of the first connecting piece 1-9, a connecting hole is formed in an upper end of the first connecting piece 1-9, and a through hole is formed in the central position of the first connecting piece 1-9, as shown in FIG. 15. The central position of the second connecting piece 1-11 is shaped as a flat cylinder, a through hole is formed in the central position of the flat cylinder, an upper end face is provided with a connector and a connecting hole, connecting pins are arranged on two sides of the second connecting piece 1-11, and a bolt through hole is formed in each connecting pin, as shown in FIG. 16. A connector is arranged a lower end of the first sleeve 1-8-1, a connecting hole is formed in an upper end of the first sleeve 1-8-1, and a through hole is formed in the central position, as shown in FIG. 14. A connecting hole is formed in an upper end of the lower sleeve 1-7, and a through hole is formed in the central position, as shown in FIG. 13. A connecting hole is formed in an upper end of the middle sleeve 1-12, a mounting hole for the movable pin 1-22 is formed in the lower end of the middle sleeve 1-12, and a through hole is formed in the central position, as shown in FIG. 17.

The present disclosure is schematically described above. The description is not restrictive, and what is shown in the accompanying drawings is only one of the implementation manners of the present disclosure, but an actual structure is not limited thereto. Therefore, if those skilled in the art are inspired by the teachings of the present disclosure, structural modes and embodiments similar to these technical solutions designed without inventive step without departing from the spirit of the present disclosure all fall within the scope of protection of the present disclosure.

1. A modular large spherical tank internal detection device with self-locking function, comprising a transmission group (1) and a detection group (2), wherein a vertical center line of the transmission group (1) coincides with a vertical center line of a large spherical tank; an upper end of the transmission group (1) is fixedly connected to a top table of the large spherical tank; a lower end of the transmission group (1) is fixedly connected to the ground; and detection group (2) is connected to a middle part of the transmission group (1).

2. The modular large spherical tank internal detection device with self-locking function according to claim 1, wherein the transmission group (1) comprises a bottom table (1-1), a lower central shaft (1-2), a first central shaft (1-3-1), a second central shaft (1-3-2), a third central shaft (1-3-3), a fourth central shaft (1-3-4), a fifth central shaft (1-3-5), a sixth central shaft (1-3-6), a seventh central shaft (1-3-7), an eighth central shaft (1-3-8), a ninth central shaft (1-3-9), a tenth central shaft (1-3-10), a gear shaft (1-4), a worm shaft (1-5), an upper central shaft (1-6), a lower sleeve (1-7), a first sleeve (1-8-1), a second sleeve (1-8-2), a third sleeve (1-8-3), a fourth sleeve (1-8-4), a fifth sleeve (1-8-5), a sixth sleeve (1-8-6), a first connecting piece (1-9), a platform (1-10), a second connecting piece (1-11), a middle sleeve (1-12), a worm gear frame (1-13), an end cover (1-14), a first motor frame (1-15), a first pinion (1-16), a first motor (1-17), a gear wheel (1-18), a second pinion (1-19), a second motor frame (1-20), a second motor (1-21), and a movable pin (1-22); a center line of the bottom table (1-1) coincides with a center line of the large spherical tank; a lower end of the bottom table (1-1) is fixedly connected to the ground; an upper end of the bottom table (1-1) is connected to a lower end of the lower central shaft (1-2); an upper end of the lower central shaft (1-2) is connected to a lower end of the first central shaft (1-3-1); an upper end of the first central shaft (1-3-1) is connected to a lower end of the gear shaft (1-4); an upper end of the gear shaft (1-4) is connected to a lower end of the second central shaft (1-3-2); an upper end of the second central shaft (1-3-2) is connected to a lower end of the third central shaft (1-3-3); an upper end of the third central shaft (1-3-3) is connected to a lower end of the fourth central shaft (1-3-4); an upper end of the fourth central shaft (1-3-4) is connected to a lower end of the fifth central shaft (1-3-5); an upper end of the fifth central shaft (1-3-5) is connected to a lower end of the sixth central shaft (1-3-6); an upper end of the sixth central shaft (1-3-6) is connected to a lower end of the worm shaft (1-5); an upper end of the worm shaft (1-5) is connected to a lower end of the seventh central shaft (1-3-7); an upper end of the seventh central shaft (1-3-7) is connected to a lower end of the eighth central shaft (1-3-8); an upper end of the eighth central shaft (1-3-8) is connected to a lower end of the ninth central shaft (1-3-9); an upper end of the ninth central shaft (1-3-9) is connected to a lower end of the tenth central shaft (1-3-10); an upper end of the tenth central shaft (1-3-10) is connected to a lower end of the upper central shaft (1-6); an upper end of the upper central shaft (1-6) is connected to the end cover (1-14); the end cover (1-14) is fixedly connected to a boss at a top end of the large spherical tank; a lower sleeve (1-7) is arranged on the lower central shaft (1-2) in a sleeving manner; an upper end of the lower sleeve (1-7) is connected to a lower end of the first sleeve (1-8-1); the first sleeve (1-8-1) is arranged on the first central shaft (1-3-1) in a sleeving manner; an upper end of the first sleeve (1-8-1) is connected to a lower end of the first connector (1-9); the first connecting piece (1-9) is arranged on the gear shaft (1-4) in a sleeving manner; an upper end of the first connecting piece (1-9) is fixedly connected to a lower end of the platform (1-10); a first through hole is formed in the middle of the platform (1-10); the platform (1-10) is arranged on the gear shaft (1-4) in a sleeving manner through the first through hole; an upper end of the platform (1-10) is connected to a lower end of the second connecting piece (1-11); the second connecting piece (1-11) is arranged on the gear shaft (1-4) in a sleeving manner; an upper end of the second connecting piece (1-11) is connected to a lower end of the middle sleeve (1-12); the middle sleeve (1-12) is arranged on the gear shaft (1-4) in a sleeving manner; an upper end of the middle sleeve (1-12) is connected to a lower end of the second sleeve (1-8-2); the second sleeve (1-8-2) is arranged on the second central shaft (1-3-2) in a sleeving manner; an upper end of the second sleeve (1-8-2) is connected to a lower end of the third sleeve (1-8-3); the third sleeve (1-8-3) is arranged on the third central shaft (1-3-3) in a sleeving manner; an upper end of the third sleeve (1-8-3) is connected to a lower end of the fourth sleeve (1-8-4); the fourth sleeve (1-8-4) is arranged on the fourth central shaft (1-3-4) in a sleeving manner; an upper end of the fourth sleeve (1-8-4) is connected to a lower end of the fifth sleeve (1-8-5); the fifth sleeve (1-8-5) is arranged on the fifth central shaft (1-3-5) in a sleeving manner; an upper end of the fifth sleeve (1-8-5) is connected to a lower end of the sixth sleeve (1-8-6); the sixth sleeve (1-8-6) is arranged on the sixth central shaft (1-3-6) in a sleeving manner; a second through hole is formed in the middle of the worm gear frame (1-13); the worm gear frame (1-13) is arranged on the sixth central spindle (1-3-6) in a sleeving manner through the second through hole; a lower end of the boss of the worm gear frame (1-13) is connected to an upper end of the sixth sleeve (1-8-6); an upper end of the boss of the worm gear frame (1-13) is connected to a lower end of the worm shaft (1-5); the first motor frame (1-15) is mounted on the bottom table (1-1); the first motor (1-17) is mounted on the first motor frame (1-15); the first pinion (1-16) is mounted on the first motor (1-17); the first gear wheel (1-18) is engaged with the first pinion (1-16); the first gear wheel (1-18) is in key connection with the lower sleeve (1-7); the second motor frame (1-20) is mounted on the platform (1-10); the second motor (1-21) is mounted on the second motor frame (1-20); the second pinion (1-19) is mounted on the second motor (1-21); the second pinion (1-19) is engaged with the gear shaft (1-4); there are two connection modes between the middle sleeve (1-12) and the gear shaft (1-4), one is that the two are connected to each other through the movable pin (1-22), and the other is that the two are not connected with each other; and the movable pin (1-22) is capable of being disassembled manually.

3. The modular large spherical tank internal detection device with self-locking function according to claim 2, wherein the first central shaft (1-3-1), the second central shaft (1-3-2), the third central shaft (1-3-3), the fourth central shaft (1-3-4), the fifth central shaft (1-3-5), the sixth central shaft (1-3-6), the seventh central shaft (1-3-7), the eighth central shaft (1-3-8), the ninth central shaft (1-3-9), and the tenth central shaft (1-3-10) have the same structure; and the first sleeve (1-8-1), the second sleeve (1-8-2), the third sleeve (1-8-3), the fourth sleeve (1-8-4), the fifth sleeve (1-8-5), and the sixth sleeve (1-8-6) have the same structure.

4. The modular large spherical tank internal detection device with self-locking function according to claim 2, wherein a thrust bearing is mounted between the lower central shaft (1-2) and the bottom table (1-1); a thrust bearing is mounted between the first sleeve (1-8-1) and the lower sleeve (1-7); a thrust bearing is mounted between the first connecting piece (1-9) and the first sleeve (1-8-1); a thrust bearing is mounted between the second connecting piece (1-11) and the gear shaft (1-4); a thrust bearing is mounted between the middle sleeve (1-12) and the second connecting piece (1-11); a thrust bearing is mounted between the middle sleeve (1-12) and the second sleeve (1-8-2); a thrust bearing is mounted between the second sleeve (1-8-2) and the third sleeve (1-8-3); a thrust bearing is mounted between the third sleeve (1-8-3) and the fourth sleeve (1-8-4); a thrust bearing is mounted between the fourth sleeve (1-8-4) and the fifth sleeve (1-8-5); a thrust bearing is mounted between the third sleeve (1-8-5) and the fourth sleeve (1-8-6); and a thrust bearing is mounted between the sixth sleeve (1-8-6) and the worm gear frame (1-13).

5. The modular large spherical tank internal detection device with self-locking function according to claim 1, wherein the detection group (2) comprises a first worm gear (2-1-1), a second worm gear (2-1-2), a first transverse shaft (2-2-1), a second transverse shaft (2-2-2), a third transverse shaft (2-2-3), a fourth transverse shaft (2-2-4), a first long connecting block (2-3-1), a second long connecting block (2-3-2), a third long connecting block (2-3-3), a fourth long connecting block (2-3-4), a first long arm (2-4-1), a second long arm (2-4-2), a third long arm (2-4-3), a fourth long arm (2-4-4), a first short connecting block (2-5-1), a second short connecting block (2-5-2), a third short connecting block (2-5-3), a fourth short connecting block (2-5-4), a first detection platform (2-6-1), and a second detection platform (2-6-2), wherein the first transverse shaft (2-2-1), the second transverse shaft (2-2-2), the third transverse shaft (2-2-3), and the fourth transverse shaft (2-2-4) are respectively connected to the worm gear frame (1-13) in the transmission group (1); the first worm gear (2-1-1) is in key connection with the first transverse shaft (2-2-1); the second worm gear (2-1-2) is in key connection with the second transverse shaft (2-2-2); the first worm gear (2-1-1) is engaged with the worm shaft (1-5) in the transmission group (1); the second worm gear (2-1-2) is engaged with the worm shaft (1-5) in the transmission group (1); the first worm gear (2-1-1) and the second worm gear (2-1-2) are symmetrically arranged on two sides of the worm shaft (1-5); a side of the first long connecting block (2-3-1) is fixedly connected to the first worm gear (2-1-1); one end of the first long connecting block (2-3-1) is connected to the first transverse shaft (2-2-1); the other end of the first long connecting block (2-3-1) is fixedly connected to one end of the first long arm (2-4-1); the other end of the first long arm (2-4-1) is fixedly connected to the first short connecting block (2-5-1); a side of the second long connecting block (2-3-2) is fixedly connected to the second worm gear (2-1-2); one end of the second long connecting block (2-3-2) is connected to the second transverse shaft (2-2-2); the other end of the second long connecting block (2-3-2) is fixedly connected to one end of the second long arm (2-4-2); the other end of the second long arm (2-4-2) is fixedly connected to the second short connecting block (2-5-2); one end of the third long connecting block (2-3-3) is connected to the third transverse shaft (2-2-3); the other end of the third long connecting block (2-3-3) is fixedly connected to one end of the third long arm (2-4-3); the other end of the third long arm (2-4-3) is fixedly connected to the third short connecting block (2-5-3); one end of the fourth long connecting block (2-3-4) is connected to the fourth transverse shaft (2-2-4); the other end of the fourth long connecting block (2-3-4) is fixedly connected to one end of the fourth long arm (2-4-4); the other end of the fourth long arm (2-4-4) is fixedly connected to the fourth short connecting block (2-5-4); an upper end of the first detection platform (2-6-1) is connected to the first short connecting block (2-5-1); a lower end of the first detection platform (2-6-1) is connected to the third short connecting block (2-5-3); an upper end of the second detection platform (2-6-2) is connected to the second short connecting block (2-5-2); and a lower end of the second detection platform (2-6-2) is connected to the fourth short connecting block (2-5-4).

6. The modular large spherical tank internal detection device with self-locking function according to claim 5, wherein the first detection platform (2-6-1), the first long arm (2-4-1), the third long arm (2-4-3), and a center connecting line of the first transverse shaft (2-2-1) and the third transverse shaft (2-2-3) form a parallelogram structure; and the second detection platform (2-6-2), the second long arm (2-4-2), the fourth long arm (2-4-4), and a center connecting line of the second transverse shaft (2-2-2) and the fourth transverse shaft (2-2-4) form a parallelogram structure.
